(19) United States
(12) Patent Application Publication
(10) Pub. No.: US 2012/0200483 A1
(43) Pub. Date: Aug. 9, 2012

(54) Timing Controller and Liquid Crystal Display Device Using the Same

(76) Inventors: Myung Kook MOON, Daegu (KR); Hyun Taek NAM, Daegu (KR)

(21) Appl. No.: 13/282,939

(22) Filed: Oct. 27, 2011

(30) Foreign Application Priority Data
Feb. 7, 2011 (KR) 10-2011-0010779

(51) Int. Cl. G09G 3/36

(52) U.S. Cl. 345/99

(57) ABSTRACT

Disclosed is a liquid crystal display (LCD) device, which facilitates to synchronize and output data being transmitted from an external system with a multi-port LVDS using 4 ports or more, and an LCD device using the timing controller, wherein the timing controller comprises a receiver which receives unsynchronized LVDS data of 4 ports or more; a synchronizer which synchronizes and outputs the data; and an arranger which arranges the data synchronized by the synchronizer, and transmits the arranged data to a gate driver and a data driver.

### CROSS REFERENCE TO RELATED APPLICATIONS

This application claims the benefit of the Korean Patent Application No. 10-2011-0010779 filed on Feb. 7, 2011, which is hereby incorporated by reference as if fully set forth herein.

### BACKGROUND OF THE INVENTION

1. Field of the Invention

The present invention relates to a timing controller, and a liquid crystal display (LCD) device using the timing controller.

2. Discussion of the Related Art

A liquid crystal display (LCD) device displays images by controlling light transmittance of liquid crystal with dielectric anisotropy by the use of electric field. For this, the LCD device includes a liquid crystal display panel with a plurality of pixel regions arranged in a matrix configuration; and a driving circuit for driving the liquid crystal display panel.

On a display area of the liquid crystal display panel, a plurality of gate and data lines are arranged in such a manner that each gate line is perpendicular to each data line so as to define each pixel region. At a crossing portion of the gate and data lines, there is a thin film transistor which is turned-on depending on a scan signal of the gate line, to thereby apply a data signal of the data line to each pixel electrode.

The driving circuit includes a gate driver for driving the gate line of the liquid crystal display panel; a data driver for driving the data line; a timing controller for controlling a driving timing of the gate and data drivers; and a power source for supplying signals for driving the liquid crystal display panel and the driving circuit.

The gate driver shifts a gate start pulse supplied from the timing controller according to a gate shift clock, whereby a scan pulse having a gate-on voltage is sequentially supplied to the gate lines, and a gate-off voltage is supplied to the gate lines for a period which is not supplied with the scan pulse. In this case, the gate shift clock supplied from the timing controller is changed in its voltage level by a level shifter, and is then supplied to the gate driver.

The data driver generates a sampling signal by shifting a source start pulse (SSP) supplied from the timing controller according to a source shift clock (SSC). Also, the data driver latches pixel data (RGB), which is inputted depending on the source shift clock (SSC), according to the sampling signal; and supplies the latched pixel data in units of horizontal lines in response to a source output enable (SOE) signal.

FIG. 1 is an exemplary view illustrating data and its waveform, the data transmitted between an external system and a timing controller applied to a related art LCD device. FIG. 2 is an exemplary view illustrating a system structure and a timing controller in a related art LCD device.

A related art LCD device includes a timing controller 14 which outputs gate and data control signals for respectively controlling gate and data drivers, receives digital video data (RGB) from an external system 10, samples and rearranges the received digital video data, and outputs the sampled and rearranged data.

The timing controller 14 outputs a gate control signal for controlling a gate driver, and a data control signal for controlling a data driver by the use of vertical/horizontal synchronous signals and clock signals; and samples and rearranges digital video data (video signal, RGB) inputted from the external system 10, and supplies the sampled and rearranged data to the data driver.

That is, the timing controller 14 is provided in communication with the external system 10. In the related art, a data transmission between the timing controller 14 and the external system 10 is made in a transistor-transistor-logic (TTL) level. However, the data transmission of TTL level necessarily requires a large number of transmission lines, whereby the number of cables and connectors are also increased, which causes the high possibility of exposing the transmission line to the external noise. Recently, a low-voltage differential signaling (hereinafter, referred to as ‘LVDS’) technology is widely used as an interface between the timing controller and the external system.

In case of the LVDS, as shown in (a) and (b) of FIG. 1, two signals with opposite polarities are generated, and data is transmitted with reference to the two signals. Thus, the LVDS enables a low-voltage data transmission, and realizes low power consumption, rapid transmission speed, and good noise-resistance properties.

In case of the LVDS, the timing controller 14 can be normally operated when timing of LVDS 1 clock is synchronized with timing of other LVDS 2˜4 data. Even though the LVDS clock is inputted to 1˜4 ports, the timing controller 14 uses only LVDS 1 clock due to easiness in design.

FIG. 2 is an exemplary view illustrating the system structure and the timing controller in the related art LCD device.

As mentioned above, the timing controller 14 controls the gate driver and the data driver by the use of video signals and various signals received from the external system 10. For this, the timing controller 14 may comprise a receiving unit 14a and a logic unit 14b.

The receiving unit 14a is connected with the external system 10. That is, the receiving unit 14a receives the video signals and various signals from the external system 10.

The logic unit 14b is connected with the gate driver (not shown) and data driver (not shown), to thereby transmit the various signals. The logic unit 14b may include a gate control signal generator, a data control signal generator, and a video signal (data) generator.

The external system 10 converts data including the video signal (RGB data) and control signals into an LVDS pattern, and then supplies the LVDS pattern to the timing controller. The control signals may include a vertical synchronous signal (Vsync), a horizontal synchronous signal (Hsync), a data enable signal (DE), and a clock signal (CLK).

The external system 10 uses a plurality of transmitting units (for example, first transmitting unit 10a and second transmitting unit 10b) as shown in FIG. 2, to thereby transmit the data in the LVDS pattern. The data of the LVDS pattern generated in the plurality of transmitting units is synchronized in a synchronizing unit 10c, and is then outputted to the timing controller.

As shown in FIGS. 1 and 2, the external system 10 comprises 4-port. The timing controller is normally operated only when the data inputted to 4 ports is timing-synchronized for 1 LVDS clock, and then the synchronized data is transmitted to the timing controller. That is, the timing controller to be supplied with 4-port input is normally operated when four of LVDS data is synchronized for 1 LVDS clock.

However, as shown in FIG. 2, in case of the related art system 10, the 4-port LVDS may be formed by the use of chips having LVDS 2-port output, that is, the first transmitting unit 10a and second transmitting unit 10b. For the timing synchronization of the LVDS data of 4 ports, the synchronizing unit 10c has to be provided in the system 10, which causes the complicated circuit structure. If needed, the synchronizing unit 10c has to be additionally formed by an expensive FPGA, which causes the increased manufacturing cost and complicated manufacturing process.

In a device such as a monitor, the system 10 generally uses two of 2-port transmitting units (LVDS Tx chip) to realize the 4 ports. In this case, since the LVDS1 and LVDS2 are outputted from the same transmitting unit, the LVDS1 is synchronized with the LVDS2. Also, the LVDS3 and LVDS4 are outputted from the same transmitting unit, the LVDS3 is synchronized with the LVDS4. However, the group of LVDS1 and LVDS2 is not synchronized with the group of LVDS3 and LVDS4 since the group of LVDS1 and LVDS2 and the group of LVDS3 and LVDS4 are outputted from the different transmitting units. However, the 4-port LVDS timing controller (T-Con) is normally operated when the LVDS1 clock is timing-synchronized with the other four of LVDS data. Thus, the related art external system 10 uses the synchronizing unit 10c made of the high-priced chip such as FPGA for the timing synchronization.

If applying the LVDS above 4 ports, the plurality of transmitting units are inevitably used so that the above problems occur.

### SUMMARY OF THE INVENTION

Accordingly, the present invention is directed to a timing controller and an LCD device using the timing controller that substantially obviates one or more problems due to limitations and disadvantages of the related art.

An aspect of the present invention is to provide a timing controller which facilitates to synchronize and output data being transmitted from an external system with a multi-port LVDS using 4 ports or more, and an LCD device using the timing controller.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, there is provided a timing controller comprising: a receiver for receiving unsynchronized LVDS data of 4 ports or more; a synchronizer for synchronizing and outputting the data; and an arranger for arranging the data synchronized by the synchronizer, and transmitting the arranged data to a gate driver and a data driver.

In yet another aspect of the present invention, there is provided an LCD device comprising: a timing controller comprising a receiver for receiving unsynchronized LVDS data of 4 ports or more, a synchronizer for synchronizing and outputting the data, and an arranger for arranging the data synchronized by the synchronizer and transmitting the arranged data to a gate driver and a data driver; and a liquid crystal display panel for displaying an image, wherein the data driver drives data lines of the liquid crystal display panel according to a data control signal transmitted from the timing controller, and the gate driver drives gate lines of the liquid crystal display panel according to a gate control signal transmitted from the timing controller.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exemplary view illustrating data and its waveform, the data transmitted between an external system and a timing controller applied to a related art LCD device;

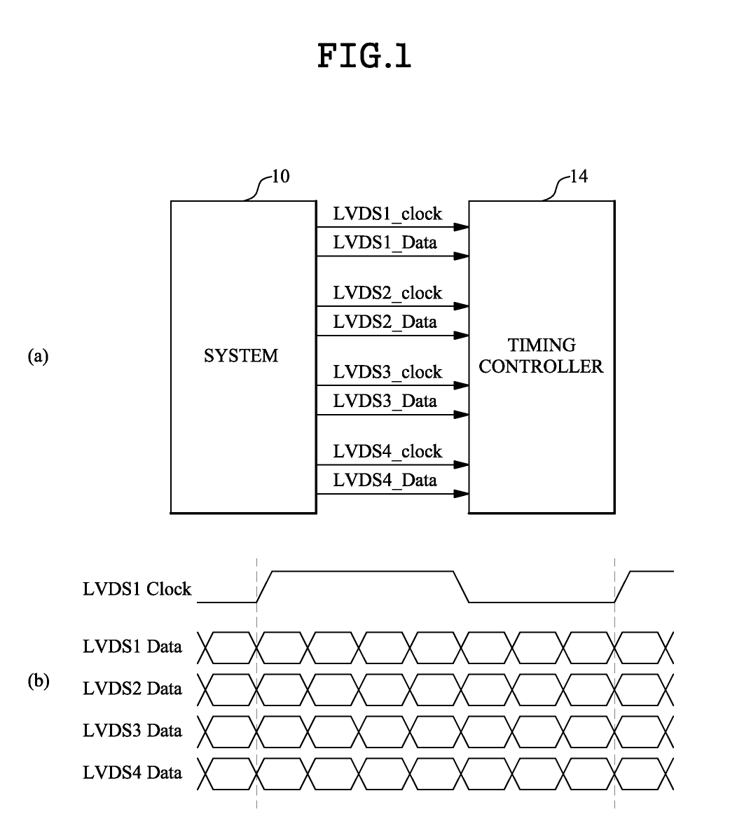

FIG. 2 is an exemplary view illustrating a system structure and a timing controller in a related art LCD device;

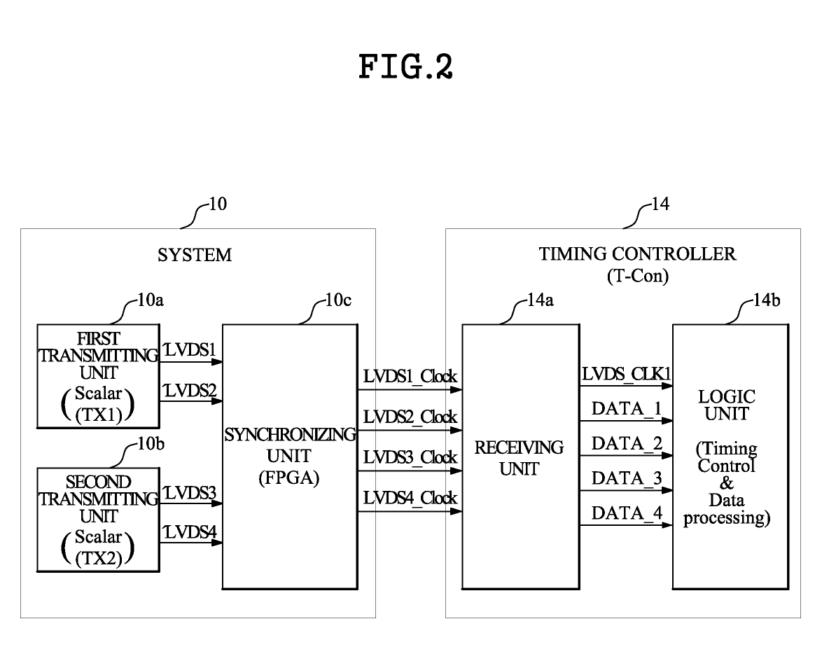

FIG. 3 illustrates an LCD device according to an embodiment of the present invention;

FIG. 4 is an exemplary view illustrating an inner structure of an external system and a timing controller according to the present invention;

FIG. 5 is an exemplary view illustrating a waveform of data inputted to a timing controller and a waveform of data outputted from a timing controller according to the present invention;

FIG. 6 is a waveform view illustrating a method for controlling writing and reading data in a read-timing controller of a timing controller according to the present invention; and

FIG. 7 is an exemplary view illustrating an arrangement of respective elements of an LCD device according to the present invention.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

Hereinafter, a timing controller according to the present invention and an LCD device using the same will be described with reference to the accompanying drawings.

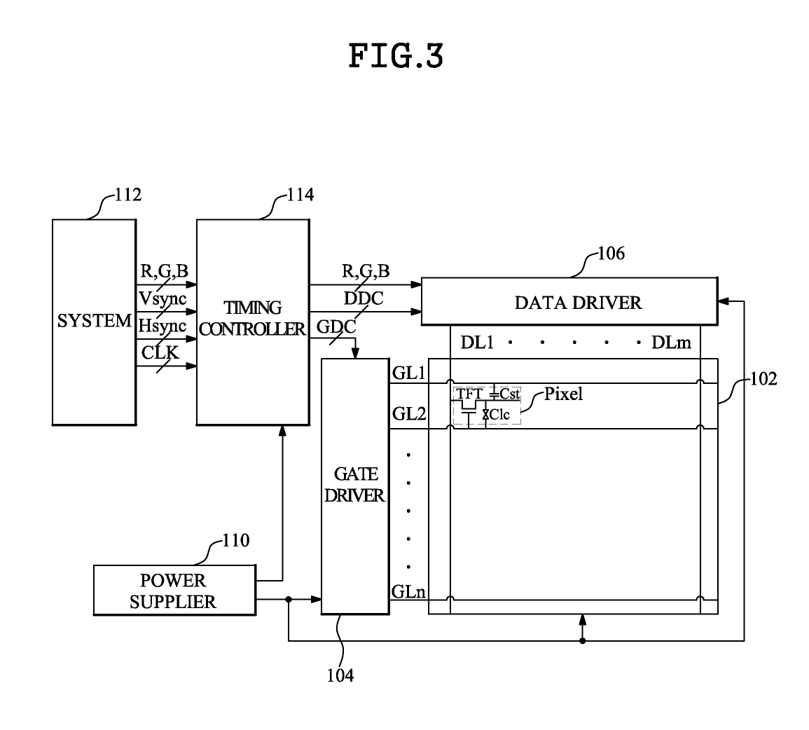

FIG. 3 illustrates an LCD device according to an embodiment of the present invention.

As shown in FIG. 3, the LCD device according to the embodiment of the present invention includes a timing controller 114, a gate driver 104, a data driver 106, a liquid crystal display panel 102, and a power supplier 110. The timing controller 114 outputs a gate control signal (GDC) and a data control signal (DDC) for respectively controlling gate and data drivers 104 and 106; receives digital video data (RGB, hereinafter, referred to as ‘video signal’) from an external system 112; samples and rearranges the received video signal; and outputs the sampled and rearranged video data. The gate driver 104 supplies a scan pulse to each gate line (GL1˜GLn) of the liquid crystal display panel 102 in response to the gate control signal (GDC). The data driver 106 supplies a pixel signal to each data line (DL1˜DLm) of the liquid crystal display panel in response to the data control signal (DDC). The liquid crystal display panel 102 includes a plurality of liquid crystal cells driven by the scan pulse and pixel signal, to thereby display an image. The power supplier 110 supplies power for driving the above elements.

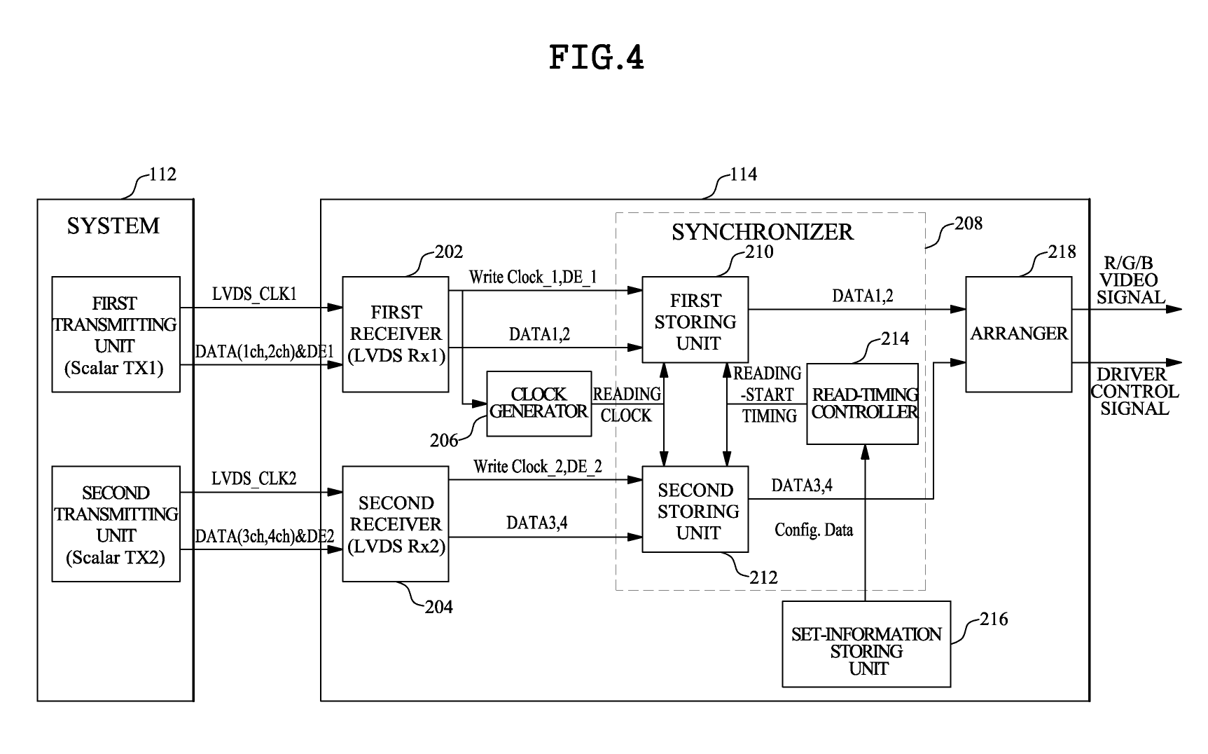

The timing controller 114 outputs the gate control signal (GDC) for controlling the gate driver 104 and the data control signal (DDC) for controlling the data driver 106 by the use of vertical/horizontal synchronous signals and clock signals. Also, the timing controller 114 samples and rearranges the video signal inputted from the external system 112, and then supplies the sampled and rearranged video signal to the data driver 106. Also, if applying a multi-port LVDS of 4 ports or more, the timing controller 114 synchronizes the data transmitted from the external system 112. A detailed structure and function of the timing controller will be explained with reference to FIG. 4.

The gate driver 104 sequentially supplies the scan pulse (gate pulse or gate-on signal) to each gate line (GL1˜GLn) of the liquid crystal display panel 102 in response to the gate control signal (GDC) transmitted from the timing controller 114, to thereby turn-on thin film transistors (TFTs) of a corresponding horizontal line.

The data driver 106 converts the data control signal (DDC) transmitted from the timing controller 114 into an analog pixel signal (data signal or data voltage) corresponding to a grayscale value of the video signal (RGB); and supplies the analog pixel signal to the data line (DL1˜DLm) of the liquid crystal display panel 102.

The liquid crystal display panel 102 includes the plurality of liquid crystal cells (Clc) arranged in a matrix configuration; and the thin film transistors (TFTs) formed at respective crossing portions of the gate lines (GL1˜GLn) and data lines (DL1˜DLm) and respectively connected with the liquid crystal cells (Clc).

In the LCD device with the above structure, the timing controller 114 receives the vertical/horizontal synchronous signals (Vsync, Hsync), clock signals (DCLK), data enable signal (DE), and video signal from the external system 112 via an interface (not shown).

The interface (not shown) converts analog video signal to digital video signal, and detects a synchronization signal included in the video signal. At this time, the video signal transmitted from the external system 112 is supplied to the timing controller 114 by the use of low-voltage differential signaling (LVDS) method.

For this, the external system 112 converts the data including the video signal (RGB data) and control signal into an LVDS pattern, and then supplies the converted data to the timing controller 114. The control signal may include the vertical/horizontal synchronous signals (Vsync, Hsync), clock signals (DCLK), and data enable signal (DE).

The external system 112 uses the LVDS method to transmit the data. In the LVDS method, two signals with opposite polarities are generated, and data is transmitted with reference to the two signals. Thus, the LVDS method enables a low-voltage data transmission, and realizes low power consumption, rapid transmission speed, and good noise-resistance properties.

Also, the external system 112 uses a plurality of transmitting units to transmit the data of the LVDS pattern. The data of the LVDS pattern generated in the plurality of transmitting units is transmitted to the timing controller 114 without an additional timing-synchronization process.

That is, the external system is mounted on a device such as a monitor. The multi-port LVDS (4 ports or more) is applied to the external system so that at least two of 2-port transmitting units (LVDS Tx chip) are used to realize the multi-port LVDS above 4 ports. Hereinafter, the external system of 4-port LVDS will be explained with reference to FIG. 4. The present invention may be applied to the external system using the multi-port LVDS above 4 ports. The external system with the multi-port LVDS above 4 ports transmits the data outputted from the plurality of transmitting units to the timing controller without an additional timing-synchronization process.

FIG. 4 is an exemplary view illustrating an inner structure of the external system and the timing controller according to the present invention. The following embodiment of the present invention shows the external system 112 with the 4-port LVDS using the two of 2-port transmitting units. However, the present invention may be readily applied to the external system with the multi-port LVDS above 4 ports.

First, the external system 112 transmitting the data by the 4-port LVDS method is to convert the data including the video signal (RGB data) and control signal into the LVDS pattern, and to supply the converted data to the timing controller 114. The control signal includes the vertical/horizontal synchronous signals (Vsync, Hsync), clock signals (CLK), and data enable signal (DE).

As shown in FIG. 4, the external system 112 includes the first 2-port transmitting unit and the second 2-port transmitting unit so as to transmit the 4-port LVDS data to the timing controller 114.

In this case, since the LVDS1 and LVDS2 are outputted from the same chip, that is, the first transmitting unit, the LVDS1 is synchronized with the LVDS2. Also, the LVDS3 is synchronized with the LVDS4 since the LVDS3 and LVDS4 are outputted from the same chip, that is, the second transmitting unit.

However, the group of LVDS1 and LVDS2, and the group of LVDS3 and LVDS4 are outputted from the different transmitting units, the two groups are not synchronized with each other, and then transmitted to the timing controller 114.

Then, the timing controller 114 rearranges the compressed video signal supplied from the external system 112, and transmits the rearranged signal to the data driver 106. Also, the timing controller 114 generates the gate control signal (GDC) and the data control signal (DDC) by the use of vertical/horizontal synchronous signals (Vsync/Hsync) and data enable signal (DE), and transmits the generated gate control signal (GDC) and data control signal (DDC) to the gate driver 104 and data driver 106.

Before generating the video signal and control signal (GDC, DDC), the timing controller 114 performs the synchronization process for synchronizing the group of LVDS1 and LVDS2 (hereinafter, referred to as ‘first group’) with the group of LVDS3 and LVDS4 (hereinafter, referred to as ‘second group’).

For this, as shown in FIG. 4, the timing controller 114 includes a first receiver 202 for receiving the data of the first group from the external system 112; a second receiver 204 for receiving the data of the second group from the external system 112; a clock generator 206 for generating clock by the use of first write clock (Write Clock_1) from the first receiver 202; a synchronizer 208 for synchronizing the data from the first receiver and second receiver; and an arranger 218 for arranging the video signal, gate control signal (GDC), and data control signal (DDC) by the use of data synchronized in the synchronizer, and outputting the arranged signals to the gate driver 104 and data driver 106.

As mentioned above, the first receiver 202 and the second receiver 204 respectively receive the data of the first group and the data of the second group transmitted from the first transmitting unit 10a and the second transmitting unit 10b included in the external system 112.

The clock generator 206 generates a reference clock to be used for writing or reading of the synchronizer 208. For this, the clock generator 206 uses the clock received in the first receiver 202.

The synchronizer 208 stores the data of the first group received in the first receiver 202, and the data of the second group received in the second receiver 204; and outputs the data of the first group and the data of the second group at a preset reading timing. For this, the synchronizer 208 includes a first storing unit 210, a second storing unit 212, and a read-timing controller 214.

As mentioned above, the first storing unit 210 and second storing unit 212 respectively store the data of the first group and second group received in the first receiver 202 and second receiver 204. At this time, the first storing unit 201 and second storing unit 212 temporarily store the data of the first group and second group, and instantly outputs the stored data. The first storing unit 201 and second storing unit 212 may be formed of FIFO (First-In-First-Out) memory with a small size.

After the data of the first group and second group is received in the respective first and second storing units 210 and 212, the read-timing controller 214 outputs the data of the first group and the data of the second group at the preset reading timing.

In order to store information indicating the reading and outputting timing of the data stored in the two storing units 210 and 212, that is, information necessary for the functions of the read-timing controller 214, there may be provided a set-information storing unit 216. At this time, the set-information storing unit 216 may be included in the synchronizer 208, or may be separately formed from the synchronizer 208 while being included in the timing controller 114.

The synchronizer 208 may comprise ‘N’ storing units (FIFO memory). At this time, ‘N’ corresponds to the number of chips used as the transmitting unit (LVDS Tx). That is, if there are the two transmitting units in the external system 112, the timing controller 114 requires the two storing units. If there are the four transmitting units in the external system 112, the timing controller 114 requires the four storing units.

Also, the size of FIFO used as the storing unit is formed to be small so as to prevent the increase of cost. According to one embodiment of the present invention, the size of FIFO used as the storing unit may be 16×60 bit. In addition, the size of FIFO may be adjusted based on the compensating timing. If using the FIFO of 16×60 bit size as the storing unit, the composition is possible even when there is the input-time difference of 15 clocks between 10 bit data transmitted from the two different transmitting units.

According to one embodiment of the present invention, data and write clock of the two FIFO memories are explained as follows.

In case of the first storing unit (FIFO1), the data of LVDS1 and LVDS2 is written by the use of LVDS1 clock. The clock and data correspond to the clock and data outputted from the first transmitting unit (Tx chip) of the external system 112.

In case of the second storing unit (FIFO2), the data of LVDS3 and LVDS4 is written by the use of LVDS3 clock. The clock and data corresponds to the clock and data outputted from the second transmitting unit (Tx chip) of the external system 112.

When the data of the two storing units (FIFO memory), that is, the first and second storing units, is read by the read-timing controller 214, it is read with the same clock. In this case, the clock may be the clock received in the first receiver or second receiver 202 or 204.

The time point when the read-timing controller 214 reads the data of the first storing unit and second storing unit 210 and 212 may be programmably controlled depending on the compensating timing, which may be stored in the set-information storing unit 216. At this time, the time point of reading the data should be smaller than the size of FIFO. If using the 16×60 bit size FIFO as the storing unit, a read-start point is set from 1 to 15, and is then stored in the set-information storing unit 216. If the read-start point is set to 8, the composition is possible even when there is the input-time difference of 8 clocks between the data of the first transmitting unit (Tx1) and the data of the second transmitting unit (Tx2).

For synchronization between the data of the first group and the data of the second group even when there is the large clock difference therebetween, the synchronizer 208 reads the data of the two groups after the input of the possibly-large number of clocks. However, the number of the clocks should be adjusted based on the size of FIFO used as the storing unit.

The arranger 218 generates and outputs the video signal (RGB) and data control signal (DDC) to be transmitted to the data driver 106 by the use of first, second, third, and fourth data synchronized by the synchronizer 208. Also, the arranger 218 generates and outputs the gate control signal (GDC).

At this time, the data control signal (DDC) may include SOE, POL1, POL2, H2DOT, CSC, and etc. The gate control signal may include GOE, GSC, GSP, and etc.

The small-sized FIFO, which is provided after the first and second receivers 202 and 204 of the timing controller 114, synchronizes the data of the first group received in the first receiver 202 with the data of the second group received in the second receiver 204.

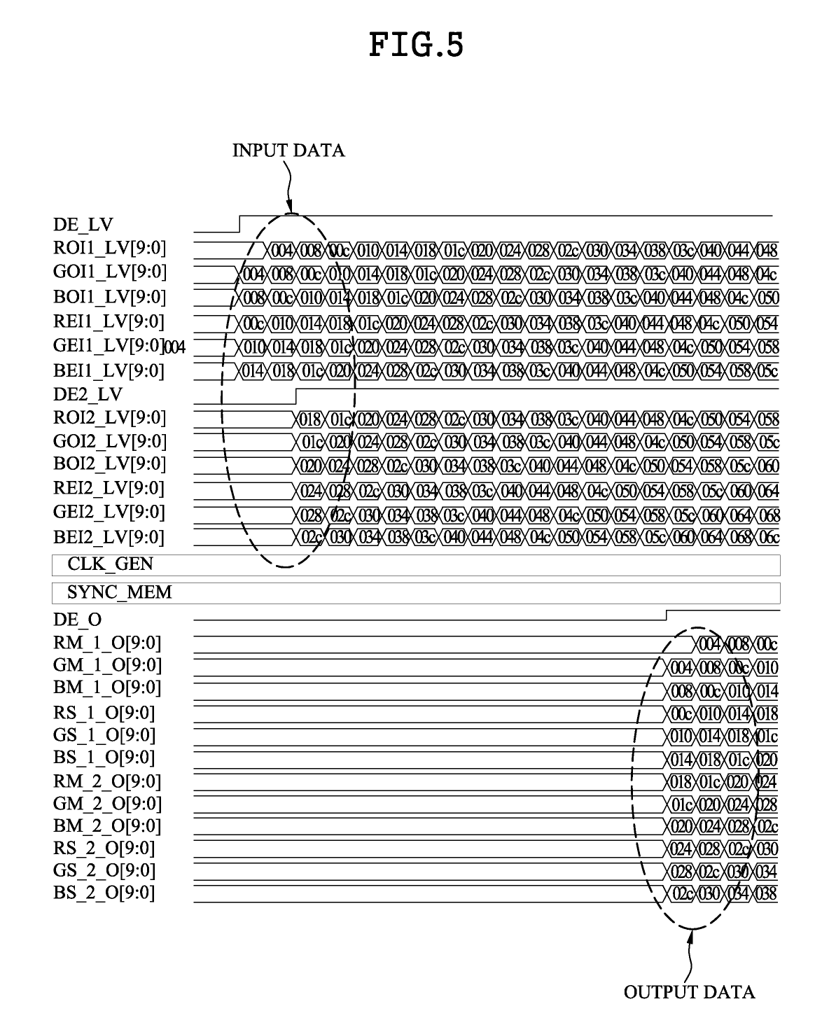

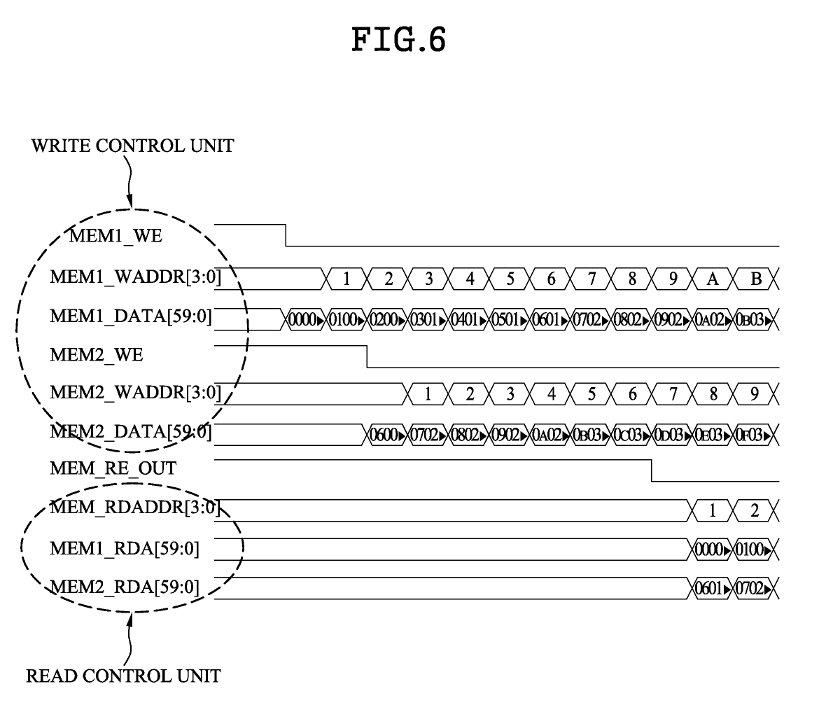

FIG. 5 is an exemplary view illustrating a waveform of data inputted to the timing controller and a waveform of data outputted from the timing controller according to the present invention. FIG. 6 is a waveform view illustrating a method for controlling writing and reading data in the read-timing controller of the timing controller according to the present invention.

Hereinafter, the present invention will be briefly explained with reference to FIGS. 5 and 6.

In the present invention, there is the synchronizer 208 for synchronizing the data for the respective ports in the timing controller (T-Com) with the multi-port LVDS input.

The synchronizer 208 includes the first and second storing unit 210 and 212 of the small-sized memory, and the read-timing controller 214.

The first storing unit 210 is used for storing the LVDS1 and LVDS2 signals, and the second storing unit 212 is used for storing the LVDS3 and LVDS4.

The read-timing controller 214 informs the read-start point of the data stored in the storing unit. The read-start point may be changeable depending on the information set in the set-information storing unit (EEPROM) 216. For example, if the read-start point of the set-information storing unit 216 is set to 8 clocks, the read-timing controller 214 restarts the reading after 8 clocks with respect to the writing point stored in the first and second storing units 210 and 212.

Thus, as shown in FIG. 5, even though the input data of the timing controller is not synchronized, it is possible to start reading the data stored in the first and second storing units 210 and 212 at the same time. Thus, the data may be outputted from the timing controller while being synchronized properly.

As shown in FIGS. 5 and 6, the LVDS input clock and data enable DE may be used for a write command of the first and second storing units 210 and 212.

For the reading command of the first and second storing units 210 and 212, the clock generated by the clock generator 206 is used, wherein a frequency of the clock generated by the clock generator 206 is the same as a frequency of the input clock of the first or second receiving unit 210 or 212.

Also, the synchronizer 208 may start reading the data with respect to a read-start timing signal outputted from the read-timing controller 214.

Meanwhile, the arranger 218 divides the data outputted from the synchronizer 208 into the video signal (RGB) and the control signal; and then transmits them to the data driver 106 or gate driver 104.

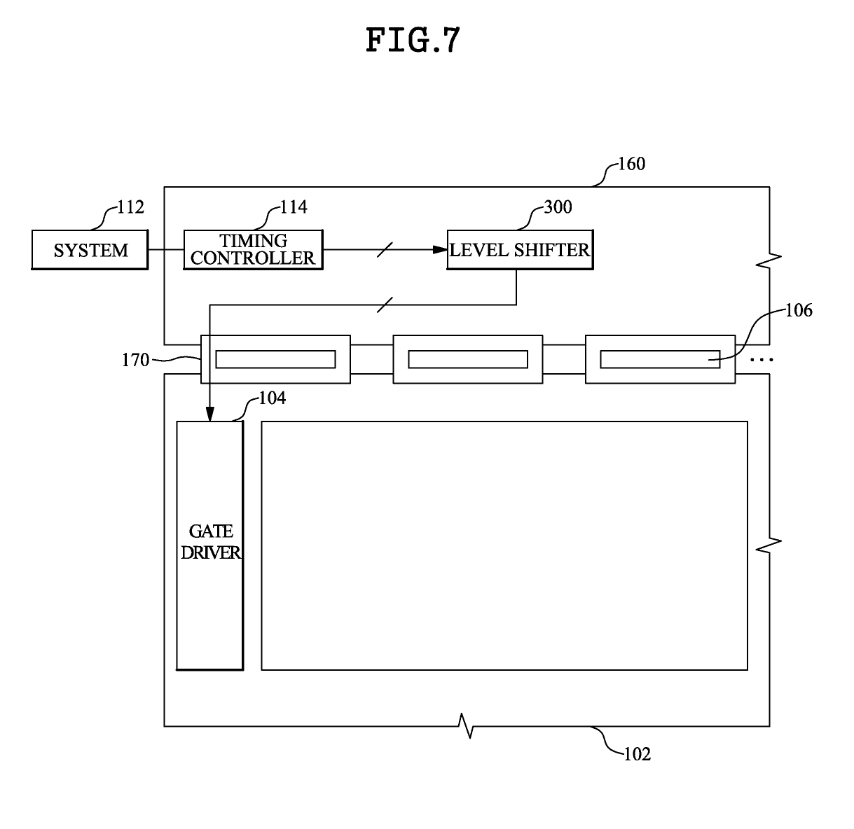

FIG. 7 is an exemplary view illustrating an arrangement of respective elements of an LCD device according to the present invention.

The LCD device according to the present invention includes a control board 160 on which the timing controller 114 and a level shifter 300 are formed; a data circuit film 170 on which the data driver 106 is formed for driving the data lines (DL1 to DLm) of the liquid crystal display panel 102; and the liquid crystal display panel 102 in which the gate driver 104 is formed.

The timing controller 114 synchronizes the unsynchronized data transmitted from the external system 112 by the use of synchronizer 208; and then outputs the synchronized data. Also, the timing controller 114 supplies the data control signal (DDC) for controlling the data driver 106 to the data driver 106 via the data circuit film 170; and supplies the gate control signal (GDC) for controlling the level shifter 300 and the gate driver 104 to the level shifter 300. The gate control signal (GDC) may include the first and second gate start pulses (GSP1, GSP2), clock signal (RCLK), and gate output enable (GOE).

The level shifter 300 generates the first to fourth gate shift clocks signals (GSC1 to GSC4) by the use of first gate start pulse (GSP1) and clock signal (RCLK) outputted from the timing controller 114; and level-shifts and outputs the generated first to fourth gate shift clock signals (GSC1 to GSC4).

The gate driver 104 includes a shift register with a plurality of stages.

In response to the input signal (that is, the second gate start pulse or the scan pulse of the prior stage), each stage selects any one of the first to fourth gate shift clock signals (GSC1 to GSC4), and outputs the selected one as the scan pulse, whereby the scan pulse is shifted in sequence. FIG. 7 shows the gate driver 104 in a GIIP (Gate-In-Panel) method, but not necessarily.

As mentioned above, the timing controller 114 according to the present invention synchronizes the unsynchronized data transmitted from the external system 112; and transmits the synchronized data to the gate driver 104 and the data driver 106.

Accordingly, the data transmitted from the external system 112 which applies the multi-port LVDS above 4 ports may be outputted while being synchronized, to thereby overcome the problem of timing synchronization among the LVDS ports.

That is, if applying the multi-port (4 ports or more) LVDS, the synchronizer 208 is additionally provided behind the receiver of the timing controller, to thereby realize the synchronization of the ports by compensating the signals unsynchronized for the LVDS ports.

In the present invention, the multi-port timing synchronization is realized in the timing controller, whereby the chip is removed from the external system 112, thereby reducing the cost of display device such as the monitor. That is, in case of the related art, the FPGA is used for synchronization of the LVDS ports. However, the present invention removes the FPGA from the system, to thereby reduce the cost.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A timing controller comprising:
a receiver which receives unsynchronized LVDS data of 4 ports or more;
a synchronizer which synchronizes and outputs the data; and
an arranger which arranges the data synchronized by the synchronizer, and transmits the arranged data to a gate driver and a data driver.

2. The timing controller according to claim 1, wherein the receiver comprises ‘N’ receiving units, each receiving unit provided with 2 ports.

3. The timing controller according to claim 2, wherein data groups received in the ‘N’ receiving units are not synchronized with one another.

4. The timing controller according to claim 2, wherein data received in any one among the ‘N’ receiving units is synchronized with data received in another among the ‘N’ receiving units.

5. The timing controller according to claim 2, wherein the synchronizer comprises:
‘N’ storing units which stores the data groups respectively received in the ‘N’ receiving units; and
a read-timing controller which outputs the data groups stored in the ‘N’ storing units at the same timing.

6. The timing controller according to claim 5, wherein each of the ‘N’ storing units is formed of FIFO (First-In-First-Out).

7. The timing controller according to claim 5, further comprising a clock generator for generating a clock required for storing the data groups in the ‘N’ storing units.

8. The timing controller according to claim 7, wherein the clock generator uses the clock, inputted to any one of the ‘N’ receiving units, so as to write or read the data groups.

9. The timing controller according to claim 5, wherein the read-timing controller starts outputting the data groups stored in the ‘N’ storing units at a point after a lapse from the preset clock after the data groups are stored in any one among the ‘N’ storing units.

10. The timing controller according to claim 9, further comprising a set-information storing unit for storing information about the preset clock.

11. An LCD device comprising:
a timing controller which comprises a receiver for receiving unsynchronized LVDS data of 4 ports or more, a synchronizer for synchronizing and outputting the data, and an arranger for arranging the data synchronized by the synchronizer and transmitting the arranged data to a gate driver and a data driver; and
a liquid crystal display panel which displays an image,
wherein the data driver drives data lines of the liquid crystal display panel according to a data control signal transmitted from the timing controller, and the gate driver drives gate lines of the liquid crystal display panel according to a gate control signal transmitted from the timing controller.
